(19) United States
(12) Patent Application Publication
(10) Pub. No.: US 2006/0209322 A1
(43) Pub. Date: Sep. 21, 2006

(54) Image forming apparatus and method

(75) Inventor: Norimasa Ariga, Shizuoka-ken (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKII KAISHA

(21) Appl. No.: 11/079,378

(22) Filed: Mar. 15, 2005

(51) Int. Cl. G06F 15/00

(52) U.S. Cl. 358/1.9; 358/518; 382/167

(57) ABSTRACT

An image-forming apparatus includes a color-conversion unit for converting a first color data value represented by a plurality of elements included in a device-independent color space into a second color data value represented by a plurality of elements included in a device-dependent color space, an image-printing unit for printing a color image by combining a plurality of different color materials based on the second color data value, and a color-reproducibility determination unit for determining that the color corresponding to the first color data value is included outside a range of colors printable by the image-printing unit when at least one of the elements of the second color data value converted from the first color data value by the color-conversion unit is included outside a predetermined reference range.

### BACKGROUND OF THE INVENTION

1. Field of the Invention

The present invention relates to an image-forming apparatus and a method for forming an image and more specifically, relates to an image-forming apparatus and a method for forming an image that enables an accurate reproduction of colors in a color image.

2. Description of the Related Art

For producing a copy of a multicolor document or a multicolor object or for displaying a multicolor document or a multicolor object, a method for displaying color based on device-dependent-color values may be used. In general, in the technical field of printing, such as color printing and color copying, the device-dependent-color values represent the subtractive primary colors of cyan (C), magenta (M), yellow (Y), and black (K). In the technical field of displays, such as electronic displays, the device-dependent-color values represent red (R), green (G), and blue (B). By using such device-dependent-color values, the colors in documents and objects can be reproduced.

Recently, a process known as ‘color design’ for selecting the colors to be used for producing a multicolor copy of a document or an object has been often carried out before actually producing the copy. Color design has been often carried out by a color-reproduction device, such as a simulation device for reproducing the colors in the document or the object and displaying these colors on a display unit or a hard-copy device for reproducing the colors in the document or the object on a printed out copy.

In case the color-reproduction device is, for example, a display unit, to display a copy of a multicolor document or an object, color data of the multicolor document or object is converted into device-dependant values, such as television signals or digital RGB output values (hereinafter referred as “RGB values”), and is output to the display unit. In case the color-reproduction device is, for example, a hard-copy device, to produce a printed out copy, color data of the multicolor document or object is converted into values representing the amount of CMYK color materials (hereinafter referred to as “CMYK values”) and is output to the hard-copy device for printing. Device-dependent-color values, such as the RGB values and the CMYK values, enables a reproduction of the colors in a multicolor document or a multicolor object to be displayed or printed out.

The device-dependent-color values, such as the RGB values and the CMYK values, depend on the characteristics of the device used to determine the colors in a document or an object, the characteristics of the phosphors and color filters of a display unit, and the characteristics of the CMYK color material. If different light sources and color measuring devices are used to determine the colors in the document or object, the colors in the document or object will be determined as different colors for each different light source or color measuring device. If a document or a object is displayed on different display units having different characteristics or if copies of a document or a object are printed out using different CMYK color materials having different characteristics, the displayed or copied document or object will be reproduced in different colors (hence, the RGB values and the CMYK values are referred to as “device-dependent-color values”).

There is a known method for producing copies of a document that accurately reproduce the colors of the original document without depending on the device used for determining the colors to be reproduced. In this known method, the colors to be reproduced are converted once into color data that does not depend on the device. For such device-independent color data, tristimulus values included in an XYZ color system standardized by the Commission Internationale de l'Eclairage (CIE) (hereinafter referred to as ‘XYZ-values’) and L*, a*, and b* values included in a CIELAB color space (hereinafter referred to as ‘Lab-values’) may be used. Hereinafter, the XYZ-values and the Lab-values are collectively referred to as ‘device-independent-color values.’

By using a color-reproduction device to convert device-dependent-color values into device-independent-color values (this process is sometimes referred to as an ‘intermediate representation method’) and to carry out color correction, color reproduction can be adjusted based on device-independent color data. As a result, stable and accurate color reproduction can be constantly carried out using color-reproduction devices having different display characteristics and CMYK color material characteristics.

Even if the above-mentioned intermediate representation method is used, the device-dependent color values and the device-independent color values may not correspond to each other in some cases because device-dependent color values, such as RGB values and CMYK values, depend on the characteristics of the color-reproduction device. The reason for the values not corresponding to each other is described below.

Device-independent color values, such as XYZ-values and Lab-values, are defined based on the spectral distribution of the light source, the spectral reflectivity or the spectral transmittance of the surface of the document or object to be reproduced, and the color matching function. Every color perceivable by the human eye can be represented by a device-independent-color value. In other words, every color that is inside the horseshoe curve of a commonly known chromaticity diagram can be represented by a device-independent color value.

On the other hand, device-dependent-color values, such as RGB values and CMYK values, may not be able to represent every color perceivable by the human eye because these values are dependent on the characteristics of the color-reproduction device. For example, in case of the CMY values (or CMYK values) used for a hard-copy device, such as a color printer or a color copier, the C, M, and Y values each have a stipulated range defined by a minimum value and a maximum value. The minimum value is equal to zero and represents a condition in which none of the cyan, magenta, or yellow color material is discharged. The maximum value substantially represents the maximum discharge amount of each color material.

Therefore, if colors are adjusted in a space represented by device-independent-color values, such as XYZ-values and Lab-values, (hereinafter this space is referred to as a ‘device-independent-color space’) and then the color data is converted into CMY values (device-dependent-color values) included a space represented by device-dependent-color values (hereinafter this space is referred to as a ‘device-dependent-color space’), the colors represented by the CMY values that are not included in the stipulated range will not be reproduced correctly by the hard-copy device.

Actually, CMY values having negative values are forcefully set to zero, and CMY values greater than the maximum value are forcefully set to the maximum value. Consequently, the colors adjusted in the device-independent-color space will differ from the colors printed out (represented) by the hard-copy device.

This is a serious problem for hard-copy devices being used for color design.

Accordingly, a determination process must be carried out to determined whether or not the colors adjusted in the device-independent-color space can be reproduced accurately using the hard-copy device.

Typically, the determination process is carried out by determining, in advance, the device-independent-color values that are reproducible by a color-reproduction device, such as a hard-copy device, defining a space represented by the reproducible device-independent-color values in a device-independent-color space represented by the device-independent-color values, and then determining whether or not the device-independent-color values to be reproduced are included in the space represented by the reproducible device-independent-color values. The determination process is carried out by approximating the reproducible device-independent-color space with polygons, mapping the device-independent-color space on a predetermined plane, or combining these steps. However, since the device-independent-color space is a three-dimensional space, an enormous number of calculations that requires an enormous amount of time must be carried out.

A determination process for determining whether or not a color is reproducible disclosed in Japanese Patent No. 3360531 simplifies the above-mentioned calculations. First, the device-independent-color value (Lab-value) of the color to be determined is converted into a device-dependent-color value (CMY value). In this conversion (first conversion), every color included in the device-independent-color space is converted and mapped on the device-dependent-color space representing the colors reproducible by a color-reproduction device (for example, a printer). Here, the device-dependent-color space is smaller than the device-independent-color space. In this way, the device-independent-color values (Lab-values) that cannot be represented by device-dependent-color values (CMY values) are forcefully associated to the device-dependent-color space representing the colors reproducible by the color-reproduction device.

Subsequently, the color data values converted into device-dependent-color values (CMY values) are converted back into device-independent-color values (Lab-values). In this conversion (second conversion), the device-dependent-color values (CMY values) that can be reproduced by the color-reproduction device representing the device-dependent-color space are mapped onto the device-independent-color space, which is a color space including all colors. Accordingly, the device-dependent-color space mapped onto the device-dependent-color space forms a subspace in the device-independent-color space.

Finally, the difference between an original device-independent-color value (Lab-value) and a device-independent-color value (Lab-value) obtained by the second conversion (or the distance between the two values in the device-independent-color space) is calculated. If the difference is greater than a predetermined value, the color corresponding to the value is determined to be non-reproducible, and if the difference is smaller than a predetermined value, the color corresponding to the value is determined to be reproducible.

If a color represented by a device-independent-color value (Lab-value) cannot be reproduced by the color-reproduction device, the value is forcefully shifted and mapped onto the device-dependent-color space after the first conversion is carried out. Consequently, the device-independent-color value (Lab-value) obtained by the second conversion and the original device-independent-color value (Lab-value) will have different values. The difference between these values is used to determine whether or not the color is reproducible by the color-reproduction device.

The determination process according to the method disclosed in Japanese Patent No. 3360531 is simpler than the determination process according to conventional methods. However, as described above, the method still requires at least two color conversion steps to determine the distance between two device-independent-color values, and the method is not simplified to a satisfactory level. Further simplification of the method is desired in order to reduce the time memory capacity required for calculation.

### SUMMARY OF THE INVENTION

Accordingly, the present invention is directed to an image-forming apparatus and method for forming an image capable of reducing the amount of processing time and the required memory capacity through a simplified process for determining whether or not a color is reproducible.

The image-forming apparatus according to an aspect of the present invention includes a color-conversion unit for converting a first color data value represented by a plurality of elements included in a device-independent color space into a second color data value represented by a plurality of elements included in a device-dependent color space, an image-printing unit for printing a color image by combining a plurality of different color materials based on the second color data value, and a color-reproducibility determination unit for determining that the color corresponding to the first color data value is included outside a range of colors printable by the image-printing unit when at least one of the elements of the second color data value converted from the first color data value by the color-conversion unit is included outside a predetermined reference range.

The method for forming an image according to an aspect of the present invention includes the steps of converting first color data values represented by a plurality of elements included in a device-independent color space into second color data values represented by a plurality of elements included in a device-dependent color space, displaying a color image by combining a plurality of light beams having different intensities based on the second color data values, and determining that a color corresponding to the first color data values is included outside a range of colors reproducible by the image display unit when at least one of the elements of the second color data values converted from the first color data values by the color-conversion unit is included outside a predetermined reference range.

### BRIEF DESCRIPTION OF THE DRAWINGS

FIG. 1 illustrates an image-forming apparatus according a first embodiment of the present invention;

FIG. 2 illustrates a detailed view of a color-conversion unit of an image-forming apparatus according an embodiment of the present invention;

FIG. 3 illustrates a process for creating a look-up table for an image-forming apparatus according an embodiment of the present invention;

FIGS. 4A and 4B schematically illustrate the content of a look-up table for an image-forming apparatus according an embodiment of the present invention;

FIG. 5 illustrates an image-forming apparatus according a second embodiment of the present invention;

FIG. 6 illustrates an image-forming apparatus according a third embodiment of the present invention; and

FIG. 7 illustrates the concept of bit manipulation of the image-forming apparatus according an embodiment of the present invention.

### DESCRIPTION OF THE PREFERRED EMBODIMENTS

An image-forming apparatus and a method for forming an image according embodiments of the present invention will be described with reference to the drawings.

### (1)First Embodiment

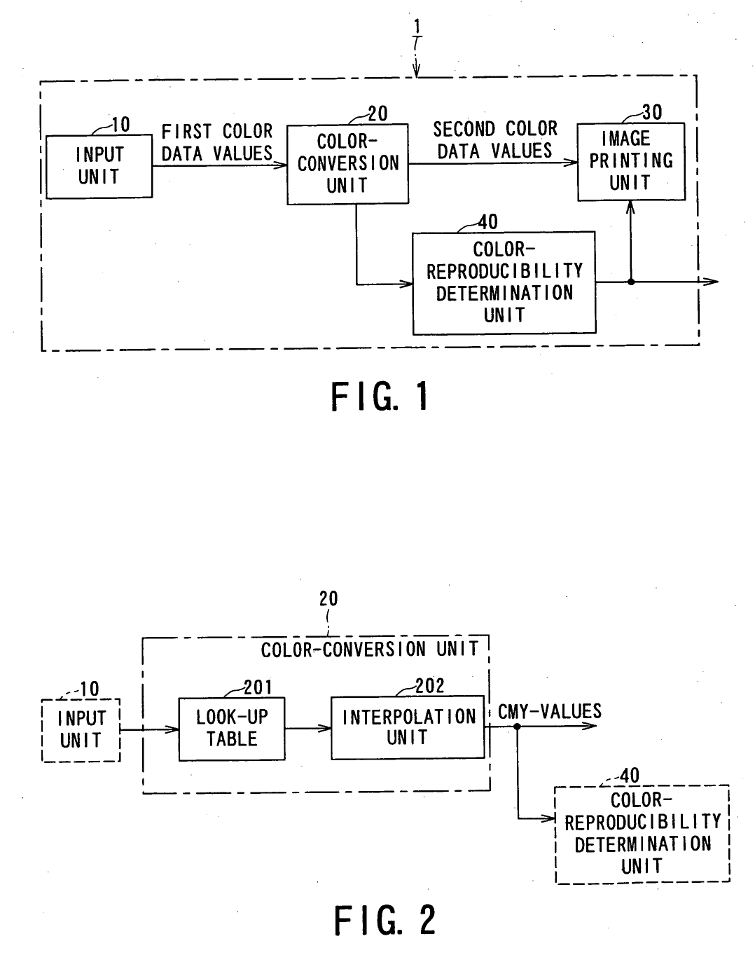

FIG. 1 illustrates an image-forming apparatus 1 according a first embodiment of the present invention.

The image-forming apparatus 1 includes an input unit 10 for inputting first color data values, a color-conversion unit 20 for converting the input first color data values into second color data values, an image-printing unit 30 for printing a color image by combining a plurality of color materials based on the second color data values, and a color-reproducibility determination unit 40 for determining that a color represented by a first color data value is not included in the range of colors printable by the image-printing unit 30 when at least one element of the second color data value that has been converted at the color-conversion unit 20 is not included in a reference range.

A first color data value corresponds to a plurality of elements (i.e., coordinates) in a device-independent-color space. A device-independent-color space is not dependant on device characteristics, such as the type of a printing device and/or the relationship between other devices. The device-independent-color space, for example, may be an XYZ color system or a CIELAB color space.

In an XYZ color system, a color is represented by a numerical value corresponding to three elements, X, Y, and Z (tristimulus values) (hereinafter, the numerical values corresponding to the three elements, X, Y, and Z, are simply referred to as “XYZ-values”).

Similarly, in the CIELAB color space, a color is represented by a numerical value corresponding to three elements, L*, a*, and b* (coordinates of the color space) (hereinafter, the numerical values corresponding to the three elements, L*, a*, and b*, are simply referred to as “Lab-values”).

The XYZ color space and the CIELAB color space have been defined by the Commission Nationale de l'Eclairage (CIE) based on the color-sensing ability of an average human being. Every color that can be perceived by the human eye can be represented by XYZ-values or Lab-values.

On the other hand, the second color data value correspond to a plurality of elements (i.e., coordinates) in a device-dependent-color space. A device-dependent color space is dependent on the device characteristics, such as the type of a printing device and/or the relationship between other devices. The device-dependent-color space, for example, may be an RGB (red, green, and blue) color space, which is used in color televisions, color displays, and scanners, or a CMY (cyan, magenta, and yellow) color space, which is used in color printing devices including color copiers and color printers.

A color represented by the same numerical value in a device-dependent-color space might be perceived as different colors depending on the characteristics of the device used to reproduce the image. For example, for a color printing device, a color represented by a set of coordinates in the CMY color space (hereinafter, the coordinates are referred to as ‘CMY values’) may appear differently each time the color is printed out because the actual color can differ depending on the type and density (or dot density) of the cyan, magenta, and yellow color materials.

In general, a device-dependent-color space does not represent every color perceivable by the human eye. It is known that part of the range of colors perceivable by the human eye cannot be reproduced by mixing colors included in a reference range (i.e., minimum to maximum density range) of cyan, magenta, and yellow color materials.

The input unit 10, illustrated in FIG. 1, inputs first color data values, such as XYZ-values or Lab-values, and may take various forms.

The input unit 10 may be a local area network (LAN), the Internet, a telephone network, or a communication interface, such as a private communication line. The input unit 10 may employ either wire communication or wireless communication.

The input unit 10 may receive first color data values from an external storage medium, such as a CD-ROM or a DVD, or from an internal storage device included in the image-forming apparatus 1, as required.

Moreover, the input unit 10 may receive first color data values from an image-generating device, such as a scanner or a digital camera. The input unit 10 may instead receive first color data values directly input via a man-machine interface, such as a keyboard, a touch panel, or a mouse.

The color-conversion unit 20 converts first color data values, such as XYZ-values or Lab-values, into second color data values, such as CMY values. The three elements of the input first color data values are converted into three different output values. The color-conversion unit 20 may be realized by hardware using a logic circuit, by executing software (program) by a CPU (computer), or by a combination of hardware and software.

The image-printing unit 30 generates a printed color image by receiving second color data values, such as CMY values. For example, a color is represented by combining color materials based on the three elements of the CMY values or based on the four elements of the CMYK values including black (K) additionally generated from the CMY value. The image-printing unit 30, for example, is a color printer, a color copier, a color facsimile machine, or a color-photograph-developing device.

The color-reproducibility determination unit 40 determines whether a color corresponding to a first color data value is included in the range of colors printable by the image-printing unit 30 based on a second color data value output from the color-conversion unit 20. More specifically, if each element of the second color data value, or, for example, a CMY value, is included in a reference range, the color-reproducibility determination unit 40 determines that the color is included in the range of colors printable by the image-printing unit 30. If at least one of the elements of the CMY value is not included in the reference range, the color-reproducibility determination unit 40 determines that the color is not included in the range of colors printable by the image-printing unit 30.

The color-reproducibility determination unit 40 may be realized by hardware using a logic circuit, by executing software (program) by a CPU (computer), or by a combination of hardware and software.

Now, the operation of the image-forming apparatus 1 having the above-described structure will be described. In the description below, first color data values are Lab-values and second color data values are CMY values.

FIG. 2 illustrates a detailed view of the color-conversion unit 20. The color-conversion unit 20 includes a look-up table 201 and an interpolation unit 202.

The look-up table 201 is a three-dimensional table for converting Lab-values input to the color-conversion unit 20 into CMY values. Since, in general, conversion from Lab-values into CMY values is non-linear, the conversion cannot be carried out by a simple matrix calculation. Thus, the look-up table 201 is used for the conversion.

The input Lab-value (L, a, and b) is used as an address value for referring to the look-up table 201. The CMY value stored at the address corresponding to the Lab-value is read out as a result of the conversion. The address (Lab-value) of the look-up table 201 is a discrete value (i.e., the look-up table 201 is formed by arranging a three-dimensional space into a grid based on these discrete values). For this reason, if the input Lab-value corresponds to an intermediate value disposed between the square units of the grid, CMY values stored at a plurality of addresses in the vicinity must be used to carry out interpolation. The interpolation process is carried out by the interpolation unit 202. However, the interpolation process itself is carried out based on known technology.

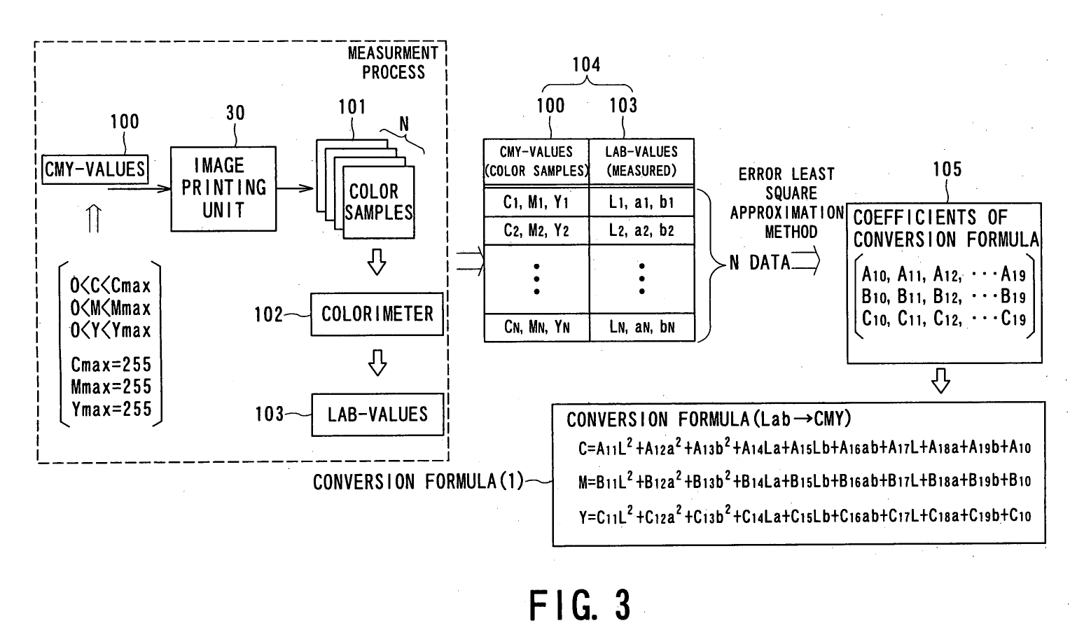

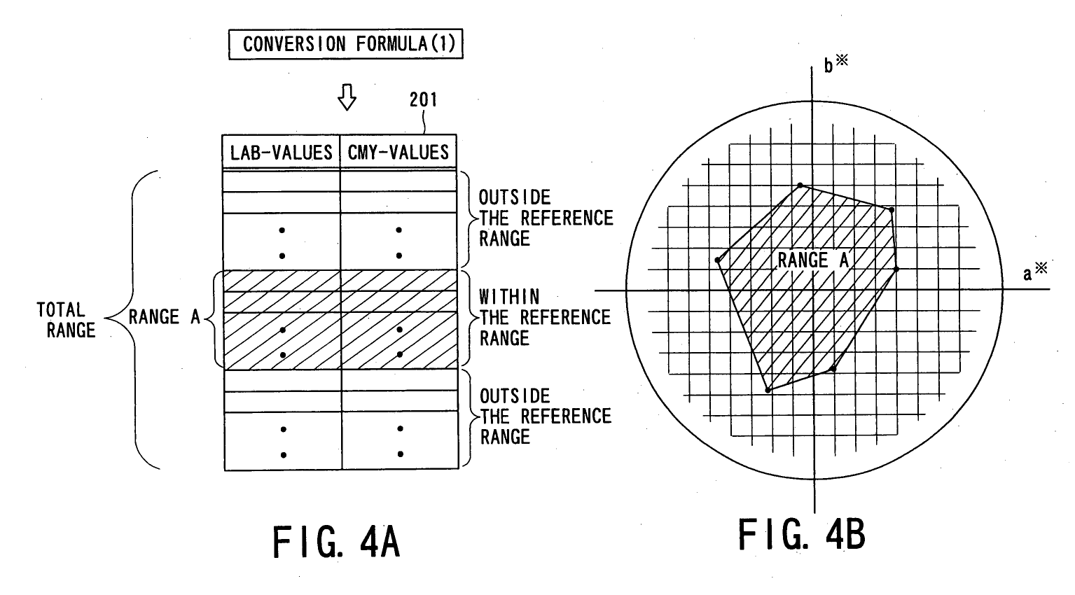

The preparation process of the look-up table 201 and the details of the content of the look-up table 201 are described with reference to FIGS. 3 and 4.

FIG. 3 illustrates the preparation process of the look-up table 201. The look-up table 201 is prepared based on data of a plurality of Lab-values 103 obtained by actually measuring a plurality of color samples 101 printed by the image-printing unit 30 with a colorimeter 102.

The plurality of color samples 101 are created by inputting a plurality of CMY values 100 into the image-printing unit 30 in order. The look-up table 201 having high accuracy can be prepared by creating color samples 101 by setting the ranges of the input CMY values 100 in order so that the ranges extend over the reference ranges for C, M, and Y from zero to the maximum value (i.e., 0≦C≦Cₘₐₓ, 0≦M≦Mₘₐₓ, 0≦Y≦Yₘₐₓ, respectively).

If the C, M, and Y values are represented by 8-bit integers, the reference range for the values will be 0≦C≦255, 0≦M<255, and 0≦Y≦255, respectively.

A measured-data table 104 is obtained from the plurality (N number of) of CMY values 100 and the measured Lab-values 103 of the plurality (N number of) of color samples 101.

On the other hand, conversion from Lab-values into CMY values is performed by using a quadratic polynomial represented by Conversion Formula (1) below:
C=A₁₁L²+A₁₂a²+A₁₃b²+A₁₄La+A₁₅Lb+A₁₆ab+A₁₇L+A₁₈a+A₁₉b+A₁₀
M=B₁₁L²+B₁₂a²+B₁₃b²+B₁₄La+B₁₅Lb+B₁₆ab+B₁₇L+B₁₈a+B₁₉b+B₁₀
Y=C₁₁L²+C₁₂a²+C₁₃b²+C₁₄La+C₁₅Lb+C₁₆ab+C₁₇L+C₁₈a+C₁₉b+C₁₀ (1)

Once the coefficients of Conversion Formula (1) are obtained, the Conversion Formula (1) will be determined and the look-up table 201 can be prepared based on the Conversion Formula (1).

Each coefficient of Conversion Formula (1) can be obtained from N pairs of the CMY values 100 and the Lab-values 103 of the measured-data table 104 based on a known error least square approximation method. The accuracy of the obtained coefficients will increase as the number of data pairs increase. For example, accuracy of the coefficients will be high if about N=1,000 data pairs are used.

In this embodiment, Conversion Formula (1) is a quadratic polynomial. However, the formula may be a higher order (n order) polynomial.

FIG. 4A illustrates a schematic view of the content of the look-up table 201. The look-up table 201 is created by assigning discrete Lab-values to the right-hand side of Conversion Formula (1) obtained based on actual measurements and storing the obtained pairs of CMY values 100 and Lab-values 103 as data of the look-up table 201.

As described above, the device-independent Lab-values represent an L*, a*, and b* color space including every color perceivable by the human eye. On the other hand, the device-dependent CMY values only represent a color space including only part of the colors perceivable by the human eye. FIG. 4B illustrates a range of colors that can be represented by CMY values in an L*, a*, and b* color space (for simplification, the values of (a*, b*) for a predetermined L value is represented two-dimensionally in the drawing). FIG. 4B illustrates a schematic view of a range A of colors that can be represented (reproduced) by CMY values.

The colors in the range A can be reproduced by combining C, M, and Y values within a reference range (this range is 0≦C≦255, 0≦M≦255, and 0≦Y≦255 when represented in 8 bits).

The colors that are not included in the range A are colors that cannot be represented by CMY values. This means, at least one of the elements of the CMY value is not included in the reference range.

This is also true for the look-up table 201. In FIG. 4A, he range of the look-up table 201 indicated by hatching corresponds to the range A. Consequently, CMY values corresponding to Lab-values are included in the reference range.

The grid illustrated in FIG. 4B schematically shows that the numerical values realized in the look-up table 201 are discrete values.

The range except of the range indicated by the hatching in the look-up table 201 indicates colors that cannot be represented (reproduced) by CMY values. CMY values corresponding to Lab-values in this range have set values that are not included in the reference range (i.e., at least one of C, M, and Y values is a negative value or greater than 255 when represented in 8 bits).

By determining whether the CMY values that are output from the look-up table 201 are included in the reference range, it can be easily determined whether or not the Lab-values are reproducible with the image-printing unit 30.

This determination process is carried out by the color-reproducibility determination unit 40 illustrated in FIG. 1. The results of the determination process are printed out by the image-printing unit 30 in suitable forms. The results may be output from the image-forming apparatus 1 so as to display the results on a suitable display unit, such as a color monitor.

The form of the results of the determination process printed by the image-printing unit 30 is not limited. For example, if a color patch for simulating a color is input from the input unit 10 to the image-printing unit 30, the results of the determination process may be printed out as characters and symbols adjacent to the color patch printed out by the image-printing unit 30. In this way, the user can easily determine whether or not the color printed by the image-printing unit 30 is an accurately reproduction of the color of the input color patch.

The image-forming apparatus 1 according to the first embodiment of the present invention is capable of easily determining whether a color printed by the image-printing unit 30 is an accurate reproduction of the input color data (a first color data value, such as a Lab-value).

The determination process is based on an extremely simple method based on determining whether the CMY values output from the look-up table 201 are included in the reference range. Hence, the required processing time is significantly reduced in comparison with other determination methods based on known technologies.

The look-up table 201 has conventionally been required for converting input first color values, such as Lab-values, into CMY values and thus is not newly added to the image-forming apparatus 1. Accordingly, the image-forming apparatus 1 according to this embodiment can be realized with a simple system configuration.

### (2)Second Embodiment

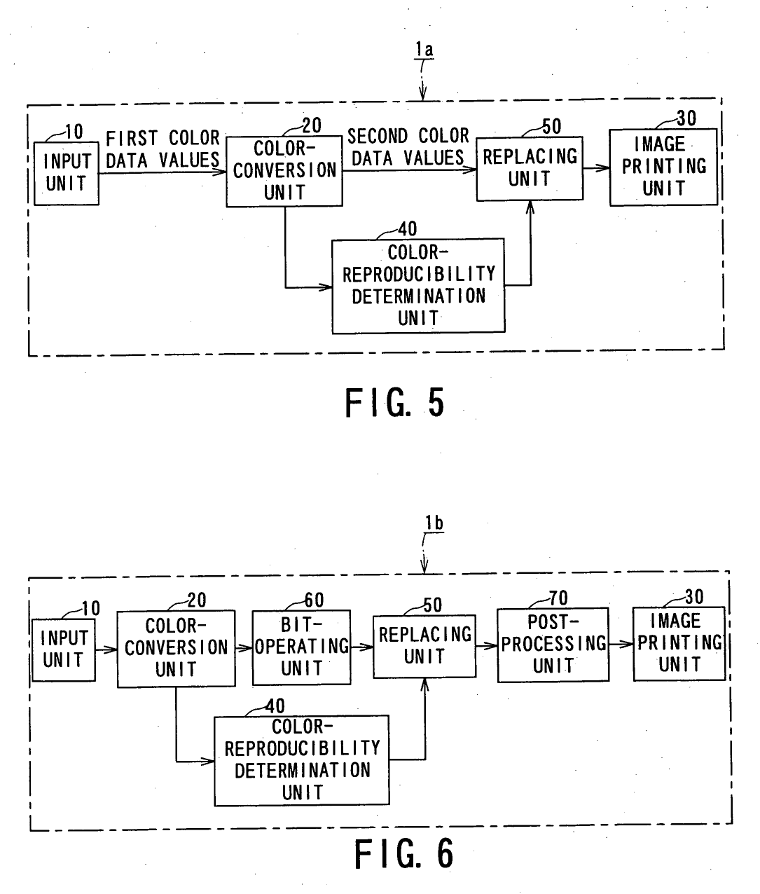

FIG. 5 illustrates an image-forming apparatus 1a according to a second embodiment of the present invention.

The image-forming apparatus 1a according to the second embodiment differs from the image-forming apparatus 1 according to the first embodiment in that a replacing unit 50 is interposed between the color-conversion unit 20 and the image-printing unit 30.

The replacing unit 50 is a unit for replacing, in pixel units, a CMY value (second color data value) output from the color-conversion unit 20 with a color data value representing a predetermined color when it is determined that the input color cannot be accurately reproduced by the image-printing unit 30.

If the input color image is a color patch or an image including a small number of colors, the results of the determination process carried out by the color-reproducibility determination unit 40 may be printed out from the image-printing unit 30 as characters and symbols.

However, if the input color image is a natural image or a complex graphical figure, the results of the determination process must be presented for each pixel, and should not be presented by text.

In such a case, the color data value of a pixel determined as reproducible is maintained and the color data value of a pixel determined as not accurately reproducible is replaced with another color data value for a color that can be easily distinguished from the surrounding colors.

The color that can be easily distinguished from the surrounding colors is not limited and, for example, may be a color greatly different from the surrounding color and easily distinguishable by the user. In particular, this color may be black, which is color obtained by performing subtractive color mixing of the three colors, C, M, and Y. The black color obtained by performing subtractive color mixing of the three colors, C, M, and Y is suitable since it is also easily distinguishable from black (K) obtained by the CMYK values.

The image-forming apparatus 1a according to the second embodiment prints out an image by replacing, in pixel units, a color that has been determined not accurately reproducible with a color easily distinguishable by the user. Therefore, in addition to the advantages of the image-forming apparatus 1 according to the first embodiment, the image-forming apparatus 1a according to the second embodiment has an advantage in that the results of the process of determining whether a color is reproducible can be easily informed to the user even when the color image is a natural image or a complex graphical figure.

### (3)Third Embodiment

FIG. 6 illustrates an image-forming apparatus 1b according a third embodiment of the present invention. The structure of image-forming apparatus 1b according to the third embodiment is the same as the structure of the image-forming apparatus 1a according to the second embodiment, except that a bit-operating unit 60 and a post-processing unit 70 are added.

The post-processing unit 70 generates black (K) from the CMY values output from the replacement unit 50 using a known technology and converts the CMY values into CMYK values. A process of under-color removal may also be carried out simultaneously. Moreover, half-tone processing may be carried out, as required. The output from the post-processing unit 70 is sent to the image-printing unit 30.

The bit-operating unit 60 is added to increase the efficiency of the determination process carried out by the color-reproducibility determination unit 40.

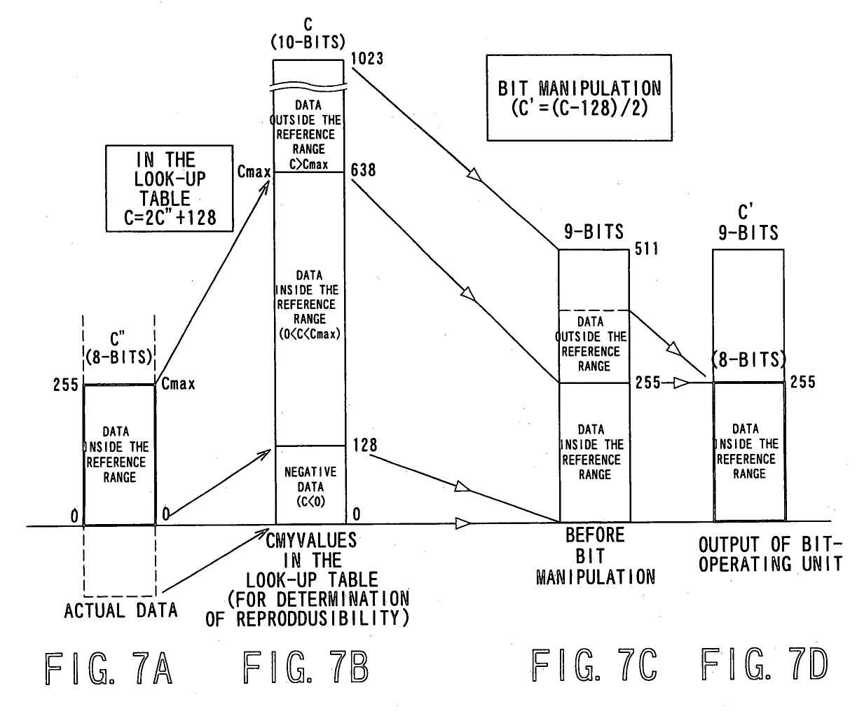

FIG. 7 illustrates details of an example of the process carried out by the bit-operating unit 60.

C, M, and Y values are often processed as 8-bit data. In such a case, each of the C, M, and Y values is represented as data included in the reference range from zero to 255.

The image-forming apparatus according to the embodiments of the present invention determines whether a color is reproducible by the image-printing unit 30 based on whether the CMY values output from the look-up table 201 is included in the reference range. Therefore, each of the C, M, and Y values stored in the look-up table 201 must have a bit width that allows values not included in the reference range to be represented.

Accordingly, the CMY values stored in the look-up table 201 according to this embodiment are expanded from 8 bits to 10 bits so that values not included in the reference range can be represented.

More specifically, a 10-bit value C=2C″+128 is store in the look-up table 201, where C″ is the 8-bit C value as illustrated in FIG. 7A (since the descriptions for an M value and a Y value are the same as the C value, here, the C value is described exemplarily).

Through this operation, as illustrated in FIG. 7B, the data included in the reference range is converted into integer data in the range from 128 to 638 and the data not included in the reference range is converted into integer data in the range from 0 to 127 or from 639 to 1023.

The 10-bit CMY values include values included inside and outside the reference range. The process for determining whether a color is reproducible is carried out by the color-reproducibility determination unit 40.

The CMY values actually output to the image-printing unit 30 cannot be values not included in the reference range. Therefore, the value must be shifted so that they are included in the reference range, and this process is carried out at the bit-operating unit 60.

More specifically, calculations according to the formula C′=(C−128)/2 are carried out by bit manipulation on the 10-bit data C output from the look-up table 201. In other words, after subtracting 128 from C, the data is shifted by a bit (i.e., the lowest bit is removed) to obtain 9-bit data in order to reduce the value by ½ (refer to FIG. 7C).

If a negative value is obtained when 128 is subtracted from C, the value is forced to zero and then shifted by a bit. If C′, obtained after being shifted by a bit, exceeds 255, C′ is forced to 255. In this way, a C value that is not included outside the reference range is forced into the reference range (refer to FIG. 7D).

In the above, the process for a C value was described. However, the processes for M and Y values are also the same.

The image-forming apparatus 1b according to the third embodiment is capable of determining whether a color is reproducible by setting the bit width of the CMY values stored in the look-up table 201 larger than the bit width of the CMY values included in the reference range. In this way, the CMY values can be treated as integer data and thus the required memory capacity can be reduced and the processing speed can be increased.

The present invention is not limited to the embodiments described above. The components of the embodiments of the present invention may be modified as long as they are within in the scope of the present invention. By combining the components disclosed in the above-described embodiments, various aspects of the present invention may be realized. For example, several components may be removed from the components included in the embodiments described above. Moreover, components included in different embodiments may be used in combination.

What is claimed is:

1. An image-forming apparatus comprising:
a color-conversion unit for converting a first color data value represented by a plurality of elements included in a device-independent color space into a second color data value represented by a plurality of elements included in a device-dependent color space;
an image-printing unit for printing a color image by combining a plurality of different color materials based on the second color data value; and
a color-reproducibility determination unit for determining that the color corresponding to the first color data value is included outside a range of colors printable by the image-printing unit when at least one of the elements of the second color data value converted from the first color data value by the color-conversion unit is included outside a predetermined reference range.

2. The image-forming apparatus according to claim 1, wherein the color-conversion unit performs conversion based on a predetermined look-up table.

3. The image-forming apparatus according to claim 2, wherein
the look-up table is created based on an n-order polynomial representing the relationship between the first color data value and the second color data value, and
coefficients in the n-order polynomial are calculated by performing a measurement of the color data of a plurality of color samples printed by the image-printing unit and by performing an error least square approximation method based on a plurality of first color data values obtained through the measurement and a plurality of second color data values used for printing.

4. The image-forming apparatus according to claim 1, wherein
the color-conversion unit converts the second color data value into an integer based on a predetermined look-up table that receives a second color data value and outputs an integer, the integer being represented by output bit number greater than a reference bit number representing an integer corresponding to the reference range,
the color-reproducibility determination unit carries out a determination process using the integer being represented by the output bit number, and
the image-printing unit prints out an image after carrying out bit manipulation so that the output bit number matches the reference bit number.

5. The image-forming apparatus according to claim 1, further comprising:
an input unit for inputting the first color data value.

6. The image-forming apparatus according to claim 1, further comprising:
a replacing unit for replacing a first color with a second color easily recognizable when the color-reproducibility determination unit determines that the first color is included outside the range of printable colors and outputting data on the second color to the image-printing unit.

7. The image-forming apparatus according to claim 1, wherein
the second color data value is a CMY value, and
the image-printing unit includes a conversion unit for converting the CMY value into a CMYK value.

8. The image-forming apparatus according to claim 1, wherein the first color data value is one of tristimulus value in a XYZ color system or an L*a*b* value in a CIELAB color space.

9. A method for forming an image comprising steps of:
converting first color data value represented by a plurality of elements in a device-independent color space into a second color data value represented by a plurality of elements in a device-dependent color space;
printing a color image by combining a plurality of different color materials based on the second color data value; and
determining that a color corresponding to the first color data value is included outside printable colors when at least one of the elements of the second color data value converted from the first color data value is included outside a predetermined reference range.

10. The method for forming an image according to claim 9, wherein the converting step is a step of performing conversion based on a predetermined look-up table.

11. The method for forming an image according to claim 10, wherein
the look-up table is created based on an n-order polynomial representing the relationship between the first color data value and the second color data value, and
coefficients in the n-order polynomial are calculated by performing a measurement of the color data of a plurality of printed color samples and by performing an error least square approximation method based on a plurality of first color data values obtained through the measurement and a plurality of second color data values used for printing.

12. The method for forming an image according to claim 9, wherein,
in the converting step, the second color data value is converted into an integer based on a predetermined look-up table that receives a second color data value and outputs an integer, the integer being represented by output bit number greater than a reference bit number representing an integer corresponding to the reference range,
in the determining step, a determination process is carried out using the integer being represented by the output bit number, and
in the printing step, an image is printed out after bit manipulation is carried out so that the output bit number matches the reference bit number.

13. The method for forming an image according to claim 9, further comprising a step of:
inputting the first color data value.

14. The method for forming an image according to claim 9, further comprising a step of:
replacing a first color with a second color easily recognizable and then printing out the second color when the first color is determined to be included outside the range of printable colors.

15. The method for forming an image according to claim 9, wherein
the second color data value is a CMY value, and
printing is carried out after post-processing including conversion of the CMY values into CMYK values is carried out.

16. The method for forming an image according to claim 9, wherein the first color data value is one of a tristimulus value in an XYZ color system or an L*a*b* value in a CIELAB color space.

17. An image-forming program executed by a computer, comprising steps of:
converting a first color data value represented by a plurality of elements in a device-independent color space into a second color data value represented by a plurality of elements in a device-dependent color space;
printing a color image by combining a plurality of different color materials based on the second color data value; and
determining that a color corresponding to the first color data value is included outside printable colors when at least one of the elements of the second color data value converted from the first color data value included outside a predetermined reference range.
